(19) United States
(12) Patent Application Publication
(10) Pub. No.: US 2020/0125958 A1
(43) Pub. Date: Apr. 23, 2020

(54) TRAINING APPARATUS, TRAINING METHOD, INFERENCE APPARATUS, INFERENCE METHOD, AND NON-TRANSITORY COMPUTER READABLE MEDIUM

(71) Applicant: PREFERRED NETWORKS, INC., Tokyo (JP)

(72) Inventors: Katsuhiko ISHIGURO, Tokyo (JP); Shinichi MAEDA, Tokyo (JP)

(73) Assignee: PREFERRED NETWORKS, INC., Tokyo (JP)

(21) Appl. No.: 16/657,389

(22) Filed: Oct. 18, 2019

(30) Foreign Application Priority Data
Oct. 19, 2018 (JP) 2018-197712
Dec. 4, 2018 (JP) 2018-227477

(51) Int. Cl. G06N 3/08; G06N 3/04; G06N 5/04; G06F 16/901; G06F 17/16

(52) U.S. Cl. CPC G06N 3/084; G06N 3/0454; G06F 17/16; G06F 16/9024; G06N 5/04

(57) ABSTRACT

A training apparatus, for training a network, including a first network and a second network, configured to infer a feature of an input graph, includes memory and a processor. The processor is configured to: merge, by the first network, first hidden vectors of first nodes of the input graph and a second hidden vector of a second node coupled to each of the first nodes, based on the first hidden vectors, the second hidden vector, and information on coupling between the first nodes. The processor is further configured to update the first hidden vectors and the second hidden vector, based on a result of the merging; extract, from the second network, the feature of the input graph, based on the updated first hidden vectors and the updated second hidden vector; calculate a loss of the feature of the input graph; and update the first network or the second network.

### CROSS REFERENCE TO RELATED APPLICATIONS

This application claims the benefit of and priority to Japanese Patent Application No. 2018-197712, filed on Oct. 19, 2018 and Japanese Patent Application No. 2018-227477, filed on Dec. 4, 2018, the entire contents of which are incorporated herein by reference.

### FIELD

The embodiments described herein relate to a training apparatus, a training method, an inference apparatus, an inference method, and non-transitory computer readable medium.

### BACKGROUND

An example of a machine learning technique widely applied to modeling or the like of a molecule and chemical compound data is a GCN (Graph Convolutional Network) inferring a hidden vector expression of each node or edge in a graph when graph data is input. Use of a GCN enables conversion of the discrete graph data into a set of hidden vectors of continuous values, thereby expressing a wide variety of tasks, such as inference of the graph characteristics, identification of toxicity in the compound graph, and providing a wide application field. The GCN starts message passing in adjacent nodes in the graph and corrects the hidden vectors of the nodes while referring to the information on neighboring nodes. The information on a far node propagates slowly through every layer, thereby making it possible to acquire the hidden vectors of the nodes obtained in the uppermost layer, which take the information of the whole graph into consideration, to some extent.

However, because information propagates slowly from a proximity node, the possibility of achieving sufficient information transmission between nodes separated by the number of layers used in practical applications is low. Even assuming a node exists for which the expression of the hidden vector of the whole graph is calculated, an information amount regarding the whole graph, such as a graph diameter or the number of nodes, is not captured as an observation amount into the model, and there is no means for balancing the weight of a message between an actual node and such a virtual node, so that the optimal hidden vector expression is not directly influenced.

### BRIEF DESCRIPTION OF THE DRAWINGS

FIG. 1 is a schematic diagram illustrating an inference apparatus according to an embodiment;

FIG. 2 is a block diagram of a training apparatus according to an embodiment;

FIG. 3 is a block diagram of a preprocessor according to an embodiment;

FIG. 4 is a block diagram of an arithmetic network in a training mode according to an embodiment;

FIG. 5 is a block diagram of a first network according to an embodiment;

FIG. 6 is a flowchart illustrating processing in the training mode according to an embodiment;

FIG. 7 is a diagram illustrating a data flow in the first network according to an embodiment;

FIG. 8 is a block diagram illustrating a function of an arithmetic network in an inference mode according to an embodiment; and

FIG. 9 is a diagram illustrating an exemplary hardware implementation of an apparatus according to an embodiment.

### DETAILED DESCRIPTION

According to one embodiment, a training apparatus for training a network, including a first network and a second network, configured to infer a feature of an input graph includes one or more processors and one or more memories. The one or more processors are configured to merge first hidden vectors of first nodes of the input graph and a second hidden vector of a second node coupled to each of the first nodes based on the first hidden vectors, the second hidden vector, and information on coupling between the first nodes. The one or more processors are further configured to: update, by the first network, the first hidden vectors and the second hidden vector, based on a result of the merging; extract, from the second network, the feature of the input graph, based on the updated first hidden vectors and the updated second hidden vector; calculate a loss of the feature of the graph; and update at least one of the first network or the second network, based on the calculated loss.

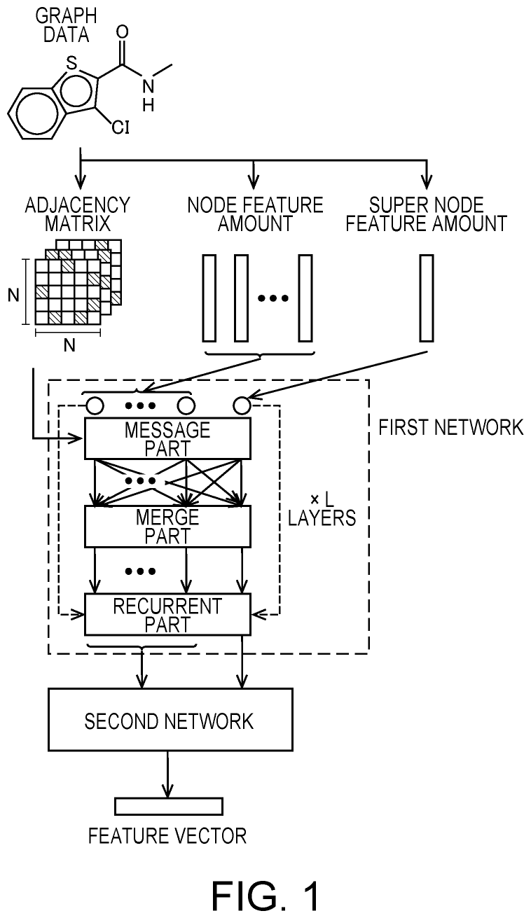

FIG. 1 is a schematic diagram illustrating functionality of an inference apparatus according to an embodiment. When graph data is input, the inference apparatus infers and outputs a feature of the input graph. For example, when a chemical formula (constitutional formula) of a compound is input, an amount indicating the feature of the compound, such as toxicity of the compound, is output. Other examples of the input graph may include a circuit diagram, a floor plan, various designs, or the constitution of a sentence (language) and so on. However, the input graph is not limited to these examples and may include any graph from which a feature is desired to be extracted.

For each of the nodes (first nodes) of the input graph, information on the feature, which each first node has, and information on coupling between the first nodes are extracted. For example, in the case where the graph is a chemical formula, a first node feature amount may be extracted as the feature of the first node from a molecule or an atom represented by each first node. The node feature may be expressed by an index, the number of edges coupled to the first node, and the like.

The coupling information may be extracted, for example, as an adjacency matrix. The adjacency matrix may be extracted as an additional matrix for each additional bond between the nodes. Alternatively, the number of bonds may be expressed as an element of the matrix. Further, the adjacency matrix may be extracted as an additional matrix for each kind of bond. For example, when the graph indicates a compound, the adjacency matrix may be extracted as an additional matrix for each kind of chemical bond, such as a π-bond, a σ-bond, or the like. Further, in the case of a directed graph, an adjacency matrix that indicates a coupling state in only one direction may be created. The above is not limiting and, alternatively, a tensor appropriately expressing the coupling between the first nodes may be extracted as the coupling information. The following will be explained using an adjacency matrix, but it should be understood that it can be restated using a tensor.

In addition to the above feature, a super node (second node) coupled to all of the first nodes is virtually created, and the feature amount of the second node is extracted. For example, when the graph is a chemical formula, the amounts such as the number of nodes of the graph, a graph diameter, or the number of kinds of the bonds between atoms is extracted as the feature amount of the second node.

In the following explanation, the first node is described as a local node and the second node is described as a super node. Both the first node and the second node may be simply referred to as a node in some cases.

The extracted feature amount of the local node is converted into a hidden vector of the local node (first hidden vector), and the feature amount of the super node is converted into a hidden vector of the super node (second hidden vector). These hidden vectors are input into a first network. The first network is configured to include a network of L (≥1) layer(s). Each layer includes a message part, a merge part, and a recurrent part.

The message part creates a message for updating the hidden vector of a certain node in the current layer, based on the hidden vector in the preceding layer of each of the nodes coupled to the certain node and on the hidden vector in the preceding layer of the certain node. The above adjacency matrix is referred to for the coupling relation between the nodes.

There are the following four kinds of messages. A first message is a message from a local node to the local node. A second message is a message from the local node to the super node. A third message is a message from the super node to the local node. A fourth message is a message from the super node to the super node. The message part creates, in each layer, the first messages and third messages corresponding to the number of local nodes and creates one each of the second message and fourth message.

The merge part creates update hidden vectors for updating the hidden vectors of each local node and the super node, based on the messages created by the message part. More specifically, a local update hidden vector (first update hidden vector) is created using the first message and third message, and a super update hidden vector (second update hidden vector) is created using the second message and fourth message.

The weighting in a merge of the first message and third message, and the weighting in a merge of the second message and fourth message are adaptively updated during training. Through the updating of the weight, the merge part operates as a gate which adaptively mixes the hidden vector of the local node and hidden vector of the super node, which have different properties.

The recurrent part applies autoregressive gating to the first update hidden vector created by the merge part and to the first hidden vector output from the recurrent part in the preceding layer, so as to update the first hidden vector. The recurrent part similarly applies gating to the second update hidden vector and to the second hidden vector output in the preceding layer so as to update the second hidden vector.

Each of the first hidden vector and second hidden vector output from the recurrent part is output to the message part in the next layer. Then, each of the first hidden vector and second hidden vector is processed in the message part, the merge part, and the recurrent part, and further output to the next layer.

The first network outputs the first hidden vector and second hidden vector updated in the recurrent part in the final layer to a second network. Based on the first hidden vector and second hidden vector output from the first network, the second network outputs a feature vector indicating the feature extracted from the graph.

Note that the first network includes the message part, the merge part, and the recurrent part. However, this is not limiting, and the first network may be configured not to include at least one of the message part or recurrent part. For example, a network may be formed in which the message part is omitted, the merge part merges and outputs tensors (each indicating some feature between the local node and the super node) and output the update hidden vector of each node, and the recurrent part updates the hidden vector. As another example, a network may be formed in which the recurrent part is omitted and the merge part outputs a merged result as the hidden vector.

Hereinafter, the components will be explained in detail while illustrating a concrete example.

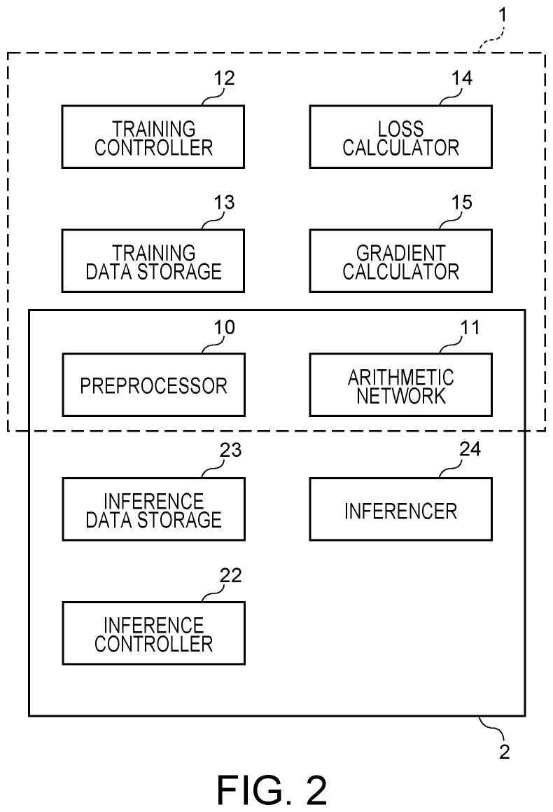

FIG. 2 is a block diagram of an inference apparatus and a training apparatus which trains the network included in the inference apparatus according to one embodiment.

A training apparatus 1 trains the network in the inference apparatus 2. A preprocessor 10 performs preprocessing by creating data to be input into an arithmetic network 11. The training apparatus 1 is an apparatus that performs training of the arithmetic network 11 using the preprocessor 10, and includes a training controller 12, a training data storage 13, a loss calculator 14, and a gradient calculator 15.

The training controller 12 acquires graph data from the training data storage 13 and converts, in the preprocessor 10, the graph data to input data to the network. The preprocessor 10 inputs the converted data into the arithmetic network 11 and sequentially propagates the data through the arithmetic network 11. The arithmetic network 11 outputs the calculated feature vector of the graph to the loss calculator 14, and the loss calculator 14 compares the feature vector with correct answer data and calculates a loss. The gradient calculator 15 calculates a gradient based on the loss calculated by the loss calculator 14 and updates the arithmetic network 11. The loss calculator 14 and the gradient calculator 15 may function, in cooperation, as a network updater.

An inference apparatus 2 includes the preprocessor 10, the arithmetic network 11 trained by the training apparatus 1, an inference controller 22, an inference data storage 23, and an inferencer 24. When the graph data is input to the inference apparatus 2, the inference apparatus outputs the feature extracted from the graph.

The inference controller 22 inputs the graph data stored in the inference data storage 23 into the arithmetic network 11 via the preprocessor 10. The inferencer 24 inferences the input feature of the graph from the feature vector output from the arithmetic network 11 and outputs the feature of the graph.

The inference apparatus 2 may include an arithmetic network 11 that processes one task, or may include a plurality of arithmetic networks 11 that process a plurality of tasks, respectively. In the case where the plurality of arithmetic networks 11 are provided, respectively, for the plurality of tasks, the inference controller 22 may switch between the arithmetic networks 11 according to the task input by a user. In this case, the user may designate the task, or the inference controller 22 may automatically determine and use a suitable arithmetic network 11, based on the type of input graph.

Further, the training apparatus 1 and the inference apparatus 2 do not need to exist separately, but may be provided in the same apparatus. In this case, the apparatus may switch between a training mode using the training apparatus 1 and an inference mode using the inference apparatus 2 to perform training and inference. After the user confirms the result inferenced by the inference apparatus 2, the result may be stored in the training data storage 13 as the training data for use by the training apparatus 1 so that the network can be further updated.

The operation of each of the configurations of the training apparatus 1 and the inference apparatus 2 will be explained.

The training controller 12 receives the training data, learning method or various settings designated by the user, and executes desired learning. The training data necessary for training is stored in the training data storage 13. The stored training data is referred to by the training controller 12 or the loss calculator 14 as necessary. The training controller 12 inputs data regarding the graph to the arithmetic network 11 via the preprocessor 10, then controls the loss calculator 14 and the gradient calculator 15 based on the output of the arithmetic network 11 to update the various parameters of the arithmetic network 11, and stores the updated parameters in the arithmetic network 11. Further, when the learning is completed, the user may be notified of the fact that the learning is completed.

The training data storage 13 stores the training data based on the task designated by the user. The training data is, for example, data on the graph itself and data about the feature to be extracted from the graph. The task may be, for example, a function such as a discriminator which discriminates the toxicity of a substance indicated by the graph, or a regression apparatus which regresses the degree of affinity that the substance has with a target substance. The training data storage 13 takes out one or more learning data sets according to a request from the training controller 12, and transmits the learning data to the preprocessor 10, the arithmetic network 11, the loss calculator 14, the gradient calculator 15, and so on.

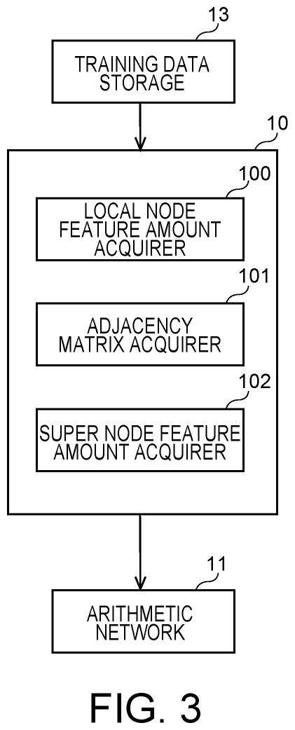

The preprocessor 10 receives the values stored in the data storages, and converts them into expressions tailored for the design of the arithmetic network 11. FIG. 3 is a block diagram of the preprocessor 10. The preprocessor 10 includes a local node feature amount acquirer 100, an adjacency matrix acquirer 101, and a super node feature amount acquirer 102.

The local node feature amount acquirer 100 extracts the feature amount of the local node and the whole graph, from the input data on the graph. For example, when the constitutional formula of the chemical compound is input as the graph, a local node feature amount is extracted as the feature amount of each first node representing a molecule or an atom expressed by an index, the number of edges coupled to the first node, and the like, as explained above.

The adjacency matrix acquirer 101 acquires, for example, an adjacency matrix of the graph as the coupling information for the local node in the graph. For example, the adjacency matrix acquirer 101 may extract the information on the edge existing between the nodes to acquire the adjacency matrix, as explained above. Rather than a single adjacency matrix, a plurality of adjacency matrices may be created based on the kind of each edge and the coupling status between the nodes as explained above.

The super node feature amount acquirer 102 extracts a super node feature amount indicating the feature amount of the whole graph. For example, in the case of a compound graph, the amount such as the number of nodes of the graph, the graph diameter, the number and kinds of the bonds between atoms or the like can be used as explained above.

The preprocessor 10 outputs the feature amount acquired by each of the components to the arithmetic network 11. The arithmetic network 11 into which each feature amount is input is subjected to learning by the training controller 12, and each of parameters forming the network is decided.

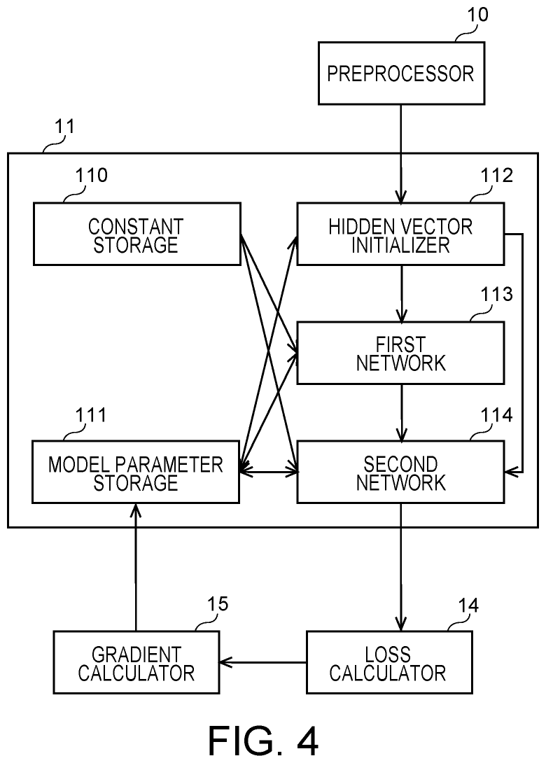

FIG. 4 is a block diagram of the arithmetic network 11 controlled by the training controller 12, namely, during learning. The arithmetic network 11 includes a constant storage 110, a model parameter storage 111, a hidden vector initializer 112, a first network 113, and a second network 114.

The constant storage 110 stores the configuration and constants of the whole network. For example, the constant storage 110 stores information on constants that are not the targets for the optimization of learning, such as the orders of the hidden vectors of the local node and super node (the first hidden vector and second hidden vector), the numbers of layers of the first network and second network, and other hyperparameters. The constant storage 110 may store a plurality of kinds of these constants corresponding to the kinds of models.

The model parameter storage 111 stores information that is the target for the optimization of learning, such as functions in the hidden vector initializer 112, the first network 113, and the second network 114, and parameters of a neural network. In a learning phase of forward propagation, parameters of the configurations are set based on the parameters stored in the model parameter storage 111, and the hidden vector is calculated. In a phase of backward propagation, the model parameter storage 111 stores the parameters updated in the configurations.

The hidden vector initializer 112 converts the feature amounts acquired by the preprocessor 10 into vectors suitable for calculation in the first network 113 and second network 114, and virtually outputs the converted vectors as hidden vectors in a 0-th layer. Hereinafter, the number of local nodes is n, and the number of layers of the first network 113 is L.

For example, in the case of using the index of an atom as the local node feature amount of a local node i, a conversion result by one-hot vectors using the index and an arbitrary function for them can be defined as a hidden vector h(0, i) of the local node i. Here, h(l, i) represents a hidden vector (first hidden vector) of an i-th local node in an l-th layer. For all of nodes i, the hidden vector initializer 112 initializes the hidden vectors h(0, i). Similarly, the adjacency matrix is also arbitrarily converted. Note that the adjacency matrix may be input without conversion into the network.

The super node feature amount is similarly converted. The hidden vector (second hidden vector) in the l-th layer of the super node is expressed as g(l), and is created by arbitrary conversion from the super node feature amount by the hidden vector initializer 112. As explained above, use of the feature amounts of the whole graph (rather than substitution of a random number as an initial value of the hidden vector of the super node) makes it possible to improve the efficiency of the learning. For example, a two-dimensional feature amount in which the number of local nodes and the number of edges are arrayed can be used as the super node feature amount, and a vector obtained by converting its two-dimensional vector by a linear or non-linear conversion scheme may be used as g(0).

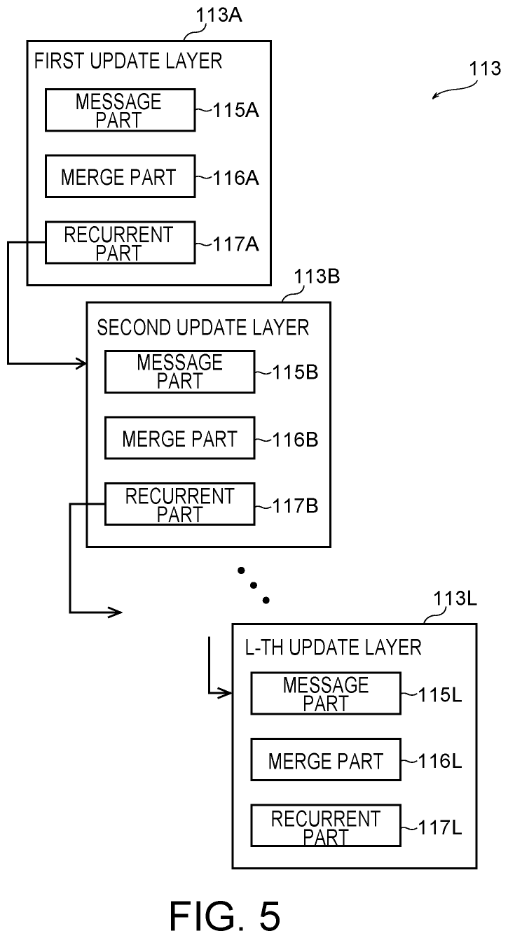

The feature amounts initialized by the hidden vector initializer 112 are input into the first network 113, and the hidden vectors are updated in each layer. FIG. 5 is a diagram illustrating an example of the configuration of the first network 113.

The first network 113 includes a network composed of L layers of a first update layer 113A, a second update layer 113B, . . . , and an L-th update layer 113L. Each of the update layers includes a message part 115, a merge part 116, and a recurrent part 117. An output of the preceding layer is input to the message part 115. In the first update layer 113A, the first hidden vector and second hidden vector initialized by the hidden vector initializer 112 are input.

The message part 115 creates a message to the nodes coupled to each other based on the input hidden vectors, and outputs the message to the merge part 116. The coupling between the nodes is referred to, for example, based on the adjacency matrix output from the hidden vector initializer 112, or similar.

The merge part 116 creates a vector for updating each of the hidden vectors based on the message input from the message part 115. The vector for updating is created by calculating a weight based on the input hidden vectors in each layer and proportionally dividing the weight and performing a merge. More specifically, the merge part 116 calculates a weight for the first hidden vector and a weight for the second hidden vector based on the first hidden vector and second hidden vector. The merge part 116 performs a merge according to the calculated weights to create the first update hidden vector and second update hidden vector. The first update hidden vector and second update hidden vector are vectors for updating the first hidden vector and second hidden vector, respectively. The created update hidden vectors are output to the recurrent part 117.

The recurrent part 117 outputs hidden vectors to be input to the next update layer based on the first hidden vector and second hidden vector in each layer and on the first update hidden vector and second update hidden vector output from the merge part 116. In the next layer, the hidden vectors output from the recurrent part 117 are input into the message part 115 of the next layer, and similar update of the hidden vectors is repeated until the L-th layer. In the final layer (L-th layer), the recurrent part 117 outputs the hidden vectors to the second network 114.

As explained above, the first network 113 calculates the update hidden vectors for updating the respective hidden vectors from the input first hidden vector and second hidden vector by proportional division, and updates the hidden vectors based on the update hidden vectors.

Returning to FIG. 4, the second network 114 creates an expression vector of the whole graph based on the first hidden vector and second hidden vector updated by the first network 113 and on the adjacency matrix. The second network 114 calculates a vector h(merged), which is merged based on n generated first hidden vectors h(L, 0:n), converts h(merged) and g(L) by an arbitrary function, and outputs a final readout vector r.

The loss calculator 14 compares the final readout vector r obtained by the second network 114 and the output given as the training data, and calculates a loss. A loss function can be an arbitrary function according to the purpose of the task of the user. For example, cross entropy can be used for an identification problem, and a square error can be used for a regression problem. Further, a function or the like included in many existing Deep Neutral Network (DNN) learning frameworks may be diverted to the loss function.

The gradient calculator 15 calculates a gradient necessary for updating variables stored in the model parameter storage 111, based on the result output from the loss calculator 14. The gradient calculator 15 updates the value of each of the parameters in the model parameter storage 111 using the calculated gradient. Generally, a value obtained by differentiating the loss function by each parameter may be used as the gradient. To implement a method of calculating the gradient and a learning rate for scaling the calculated gradient and so on, the function, setting or the like of the existing DNN learning framework may be diverted.

As explained above, the training controller 12 controls the configurations of the preprocessor 10, the model parameter storage 111, the loss calculator 14, and the gradient calculator 15 to thereby train the first network 113 and second network 114.

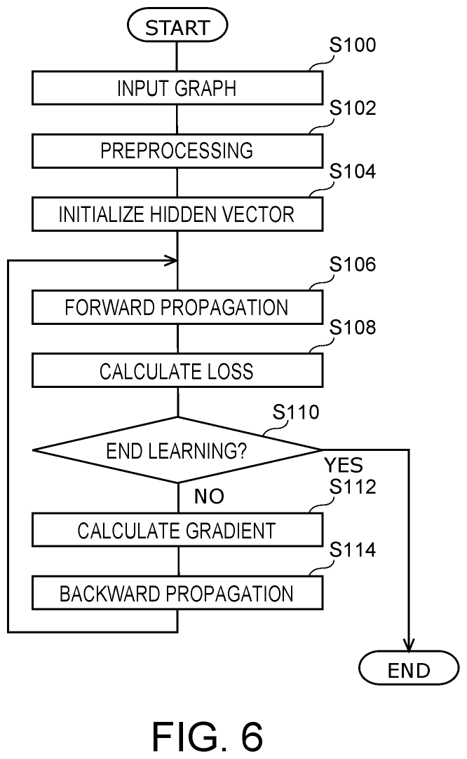

FIG. 6 is a flowchart illustrating the flow of the above-explained training.

First, the data on the graph is input (S100). The input of the graph data is not, for example, input of every graph, but graph data is accumulated in the training data storage 13 and input as needed by the training controller 12 as explained above.

Next, the preprocessor 10 performs preprocessing on the data (S102). As explained above, the preprocessor 10 extracts each feature amount from the input graph data and performs preprocessing on the data.

Next, the hidden vector initializer 112 initializes the first hidden vector and second hidden vector using the data preprocessed by the preprocessor 10 (S104). The hidden vector initializer 112 may also perform the processing involved in performing conversion on the adjacency matrix.

Next, the initialized hidden vectors are input into the first network 113 and second network 114 and are forward propagated through the network (S106). This processing may be performed by the training controller 12, or may be performed by a hidden vector calculator and layer update calculator, which are additionally provided.

Next, the loss calculator 14 compares the result output from the second network 114 with the data on the result stored in the training data storage 13 and calculates a loss (S108).

Next, the training controller 12 determines whether or not to end the learning (S110). In the case of ending the learning (S110: YES), the processing is ended. The ending of the learning may be, but not limited to, based on the loss value calculated by the loss calculator 14 (S108). If another determination method is used, S110 may be processed before S108. The other determination method may be, for example, a generally used method based on ending of the processing for a predetermined number of epochs, decreasing of a cross verification value to be lower than a predetermined threshold, or the like.

In the case of not ending the learning (S110: NO), the learning is continued. The gradient calculator 15 finds a differential value of the loss calculated by the loss calculator 14 with respect to each parameter to calculate a gradient for each parameter (S112). For the calculation of the gradient, a simple differentiation may be used, but variously devised general methods may also be used.

Next, the training controller 12 backward propagates the calculated gradient to update the parameters of the network (S114). The updated parameters are stored in the model parameter storage 111. The operation from the forward propagation is repeated using the updated parameters, and the training is performed until the end condition of the learning is satisfied. As explained above, the training controller 12 may function as a network update part which updates the network, or the training apparatus 1 may additionally include a network update part. The learning may be made more efficient by using a mini batch process or the like.

In the following, the network update part will be explained as the one updating both of the first network 113 and the second network 114. However, this is not limiting, and the network update part may instead be limited to updating only one of them. In other words, the network update part may not update the parameters of the second network 114, but may update only the parameters of the first network 113, or may conversely not update the parameters of the first network 113, but may update only the parameters of the second network 114.

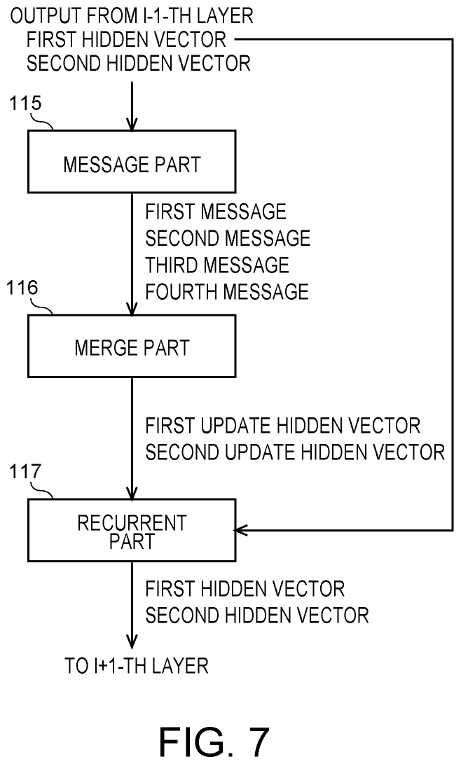

Next, the processing inside the first network 113 will be explained in detail. FIG. 7 is a diagram illustrating the flow of the data in the l-th layer. The equations and the like in the following explanation are illustrated as examples, and do not mean that other equations are not used in the framework of this embodiment.

The message part 115 first acquires the first hidden vector and second hidden vector output from an (l−1)-th layer. In the case of the l-th layer, the message part 115 acquires the hidden vectors initialized by the hidden vector initializer 112.

The message part 115 creates a message being a parameter which indicates a degree to which the hidden vectors influence updating between the coupled nodes. In other words, the message part 115 creates four kinds of messages, such as n first messages from the local node to the local node, a second message from the local node to the super node, n third messages from the super node to the local node, and a fourth message from the super node to the super node.

The first message is for digitizing the degree of influence on each local node from the local node(s) coupled thereto. Note that the local node coupled thereto is a concept also including the own node. First, it is assumed that k=1, . . . K, such that K kinds of heads are prepared. For each of the heads, the message of the local node is created. The heads are to acquire different kinds of information, respectively. Use of a plurality of heads enables calculation of a plurality of kinds of degrees of incidence on one hidden vector, thereby improving the performance of extraction of the feature amount. In each head k, for example, calculation is performed using a different parameter and a different function.

First, a weight (attention weight, a) indicating the strength of the relationship between h(l−1, i) and another local node is calculated. The attention weight from a local node j to a local node i in the l-th layer, the local node i, and the head k, is calculated from an arbitrary linear or non-linear function using h(l−1, i) and h(l−1, j) as inputs. In this calculation, the coupling between the local node i and the local node j is extracted from the adjacency matrix, and a different arithmetic operation is performed depending on the kind of the coupling (edge). When creating the first message, the calculation is not performed by extracting the coupling status between nodes, but may be performed by setting the attention weight to 0 when no edge exists.

The attention weight from the local node j to the local node i in the l-th layer, i.e., the head k, is a real value of 0 or more, and is calculated, for example, by the following equation.

α_{l,i,j,k}=softmax(h_{l,i}^{T}A_{l,e}_{_{i,j}}_{,k}h_{l,j}) (eq. 1)

Here, softmax( ) is a softmax function, the vector or T at the upper right in the matrix represents transposition, and A is a parameter updated by learning.

Attention weights a are obtained for all of nodes j and then normalized so that the sum of the attention weights for the node i becomes 1. A weighted sum of hidden vectors (l−1, j) of all of the nodes j coupled to the node i is calculated using the obtained attention weights as illustrated in the following. This calculation uses an arbitrary function.

$${\tilde{h}}_{l , i , k} = {U}_{l} {h}_{l , i} + {\sum }_{j ∈ {N}_{i}} {α}_{l , i , j , k} \text{?} \\ \text{?} \text{indicates text missing or illegible when filed} \qquad ( eq . 2 )$$

Here, U and V are parameters updated by learning. Further, N, represents a node coupled to the node i. In the case where the attention weight α between nodes which are not coupled is 0, Nᵢ does not always need to be set. Otherwise calculation may be performed between all of the nodes. Nᵢ can be freely designed in consideration of the memory usage and the cost of the calculator.

After vectors h˜_{i, j, k} indicated in (eq. 2) are calculated for all of the heads k, a vector obtained by integrating them is calculated to create the first message. The integrating method may be implemented by simply combining K weighted sums, or may be implemented by further converting them by an arbitrary function. The message part 115 calculates, for example, a vector h˜_{l, i} made by integration based on the following equation and outputs it as the first message.

\tilde{h}_{l,i}=tan h(Wₗ concatₖ [\tilde{h}_{l,i,k}]) (eq. 3)

Here, tan h( ) means a hyperbolic tangent, and concatₖ means the concatenation or combining of vectors obtained for each k. Further, W is a parameter updated by learning. The first message is created for each node i so that n messages are created in total.

The second message is a parameter passed from each local node to the super node. For example, the second message for the super node is created based on the hidden vectors of all of the local nodes in the l−1-th layer. In the K kinds of heads, the second message is similarly obtained using a different parameter and function for each head.

First, an attention weight β indicating the strength of the relationship between g(l−1) and each h(l−1, i) is calculated. Similar to the aforementioned attention weight α, attention weight β is a real value obtained by an arbitrary linear or non-linear function. Similar to the attention weights α, attention weights β are normalized so that the sum of attention weights β for the node i becomes 1. The message part 115 calculates the attention weight β, for example, based on the following equation.

β_{l,i,k}=softmax(gₗ^{T} B_{l,k} h_{l,i}) (eq. 4)

Here, B is a parameter updated by learning.

After attention weights β are obtained for all of the nodes i, weighted sums of hidden vectors h(l−1, i) are calculated for all of the nodes i.

$${\tilde{h}}_{I , super , k} = {\sum }_{i} {β}_{l , i , k} {V}_{I , k}^{( S )} {h}_{l , i} \qquad ( eq . 5 )$$

Here, V^{(S)} is a parameter updated by learning.

After vectors h˜_{i, super, k} indicated in (eq. 5) are calculated for all of the heads k, a vector obtained by integrating them is calculated to create the second message. The integrating method is the same as above The message part 115 calculates, for example, a vector h˜_{l, super} made by integration based on the following equation (eq. 6) and outputs it as the second message.

\tilde{h}_{l,super}=tan h(Wₗ^{(S)} concatₖ [\tilde{h}_{l,super,k}]) (eq. 6)

Here, W^{(S)} is a parameter updated by learning.

The third message is a parameter passed from the super node to each local node. For example, the third message for each local node is created based on the hidden vector of the super node in the l−1-th layer. The message part 115 converts g(l−1) by an arbitrary linear or non-linear function to create the third message for the local node i.

The message part 115 calculates n vectors g˜_{l, i}, for example, based on the following equation and outputs them as the third message.

\tilde{g}_{l,i}=tan h(Fₗ gₗ₋₁) (eq. 7)

Here, F is a parameter updated by learning.

The fourth message is a parameter passed from the super node to the super node. For example, the fourth message is created based on the hidden vector of the super node in the l−1-th layer. The message part 115 converts g(l−1) by an arbitrary linear or non-linear function to create the fourth message.

The message part 115 calculates g˜_{l, super}, for example, based on the following equation and outputs it as the fourth message.

\tilde{g}_{l,super}=tan h(Fₗ^{(S)} gₗ₋₁) (eq. 8)

Here, F^{(S)} is a parameter updated by learning.

As explained above, the message part 115 calculates a parameter indicating a degree to which the coupled nodes influence each other, based on the first hidden vector and second hidden vector.

The first to fourth messages created by the message part 115 are input into the merge part 116. The merge part 116 integrates the messages to create the first update hidden vector and second update hidden vector, which become update plans of the first hidden vector and second hidden vector, and outputs them.

The merge part 116 outputs a vector becoming an update plan of the hidden vector of each local node i from the first message and third message. In other words, the merge part 116 outputs n first update hidden vectors, which become update plans of n first hidden vectors corresponding to each local node. The same processing is performed on each local node i.

A first gate weight, which is a proportionally divided weight of the first message and third message, is calculated. The merge part 116 creates the first gate weight of the local node i in the l-th layer by converting the first message and third message using a linear or non-linear arbitrary function. The first gate weight is expressed as a vector, each element of which takes a real value z, where 0≤z≤1. The merge part 116 calculates the first gate weight, for example, as follows.

z_{l,i}=σ(G_{l,1}\tilde{h}_{l,i}+G_{l,2}\tilde{g}_{l,i}) (eq. 9)

Here, σ is, for example, a sigmoid function, and G is a parameter updated by learning.

This first gate weight is created from the first message and third message, and makes it possible to automatically and adaptively merge the messages. Using the calculated first gate weight as a proportional division rate, the merge part 116 creates the first update hidden vector for the local node i. Note that the proportional division may be a simple linear weighted sum of components or may be obtained by using a further complex arbitrary function. The merge part 116 creates the first update hidden vector, for example, as follows.

ĥ_{l,i}=(1−z_{l,i})\tilde{h}_{l,i}+z_{l,i}\tilde{g}_{l,i} (eq. 10)

Similarly, a second gate weight, which is a proportionally divided weight of the second message and fourth message, is calculated, and the second update hidden vector is created.

z_{l,super}=σ(G_{l,1}^{(S)}\tilde{h}_{l,super}+G_{l,2}^{(S)}\tilde{g}_{l,super}) (eq. 11)

ĝₗ=(1−z_{l,super})\tilde{h}_{l,super}+z_{l,super}\tilde{g}_{l,super} (eq. 12)

As explained above, the merge part 116 functions as a gate which proportionally divides a plurality of kinds of data different in property from each other and integrates them. The first update hidden vector h\hat{ }_{l, i} and second update hidden vector g\hat{ }ₗ which are created by the merge part 116 are input into the recurrent part 117.

The recurrent part 117 creates the first hidden vector and the second hidden vector, which are the output of the l-th layer, using all of the first hidden vectors, the second hidden vector, all of the first update hidden vectors, and the second update hidden vector in the l-th layer. The recurrent part 117 then outputs the first hidden vector and the second hidden vector.

The first hidden vectors are calculated in the local nodes i, and all of them are output as first hidden vectors in the l-th layer. For this calculation, a recurrent network having the gating function, such as a general LSTM (Long-Short Term Memory), GRU (Gated Recurrent Unit), or the like, is used. For example, the recurrent part 117 may create the first hidden vector in the l-th layer using a GRU that uses the first hidden vector in the (l−1)-th layer and the first update hidden vector created by the merger part 116 as follows.

h_{l,i}=GRU(ĥ_{l-1,i}, h_{i-1,i}) (eq. 13)

Similarly, the recurrent part 117 updates the second hidden vector using the second hidden vector and second update hidden vector. For example, the recurrent part 117 may create the second hidden vector in the l-th layer using a GRU that uses the second hidden vector in the (l−1)-th layer and the second update hidden vector created by the merger part 116 as follows.

g_{l,i}=GRU(ĝ_{l-1,i}, g_{l-1,i}) (eq. 14)

The first hidden vector and second hidden vector in the l-th layer output from the recurrent part 117 are an input to an (l+1)-th layer, and updating of the hidden vectors is repeated until the L-th layer. The hidden vectors output in the L-th layer are an output of the first network 113.

The first hidden vector and second hidden vector output from the first network 113 are input into the second network 114. The second network 114 calculates the expression vector of the whole graph using the calculated and updated first hidden vector and second hidden vector, and the adjacency matrix.

First, the number of vectors, namely, the number n of local nodes is different for each graph data, and therefore the n vectors are contracted into one fixed-length vector. The n first hidden vectors output from the first network 113 are input into an arbitrary contraction function, for example, a function such as a simple average, DNN (Deep Neutral Network), or Setout function, and converted into a single vector h(merged) of a fixed length.

Next, the second network 114 inputs h(merged) and g(L) into an arbitrary function, and outputs the readout vector r. For example, the readout vector r may be calculated using a DNN as follows.

r=DNN(concat [h_{merged}, g_{L}]) (eq. 15)

The loss calculator 14 calculates a loss using the calculated readout vector r. The calculation of the loss may be performed using a generally used loss function as explained above, or using a new linear or non-linear arbitrary function as long as it enables appropriate calculation of the loss.

The gradient calculator 15 finds the gradient to each parameter based on the loss calculated by the loss calculator 14.

The training controller 12 backward propagates the gradient through the first network and second network to thereby update the parameters of each of the networks.

The parameters inside the message part 115, merge part 116, and recurrent part 117 are different in each layer. In other words, they perform merging at an appropriate proportional division ratio in each layer and update the first hidden vector and second hidden vector. Similarly, in the training, the gradient calculator 15 calculates the gradient for the parameter in each layer. Based on the gradient for each parameter calculated in each layer, the training controller 12 performs backward propagation to update the parameter.

Note that the sigmoid function or the like may be any function as long as it appropriately takes a value between 0 and 1 and can be differentiated. Further, the function may be a function which cannot be differentiated, or a function whose gradient can be appropriately found by the gradient calculator 15.

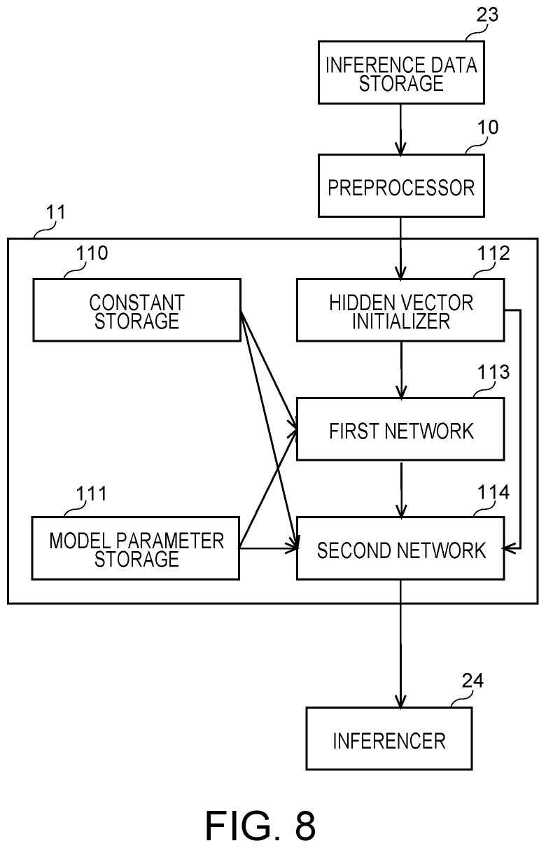

FIG. 8 is a diagram illustrating an example of the configuration of an arithmetic network in an inference mode. The inference mode or the inference apparatus 2 includes the arithmetic network 11 using the parameters optimized by the above-explained training apparatus 1. In the inference mode, the user may designate the type of the input graph, and the inference controller 22 may select appropriate parameters from the constant storage 110 and model parameter storage 111 based on the designated type of input graph, and form the first network 113 and second network 114. However, this is not limiting, and the type of the input graph data may be automatically determined, and the inference controller 22 of the inference apparatus 2 may automatically acquire model parameters and so on and form the networks based on the automatically-determined type of input graph data.

The inference controller 22 inputs the data stored in the inference data storage 23 or the data which is an inference target input by the user and processed by the preprocessor 10, into the arithmetic network 11. The input data is converted into the first hidden vector and second hidden vector in the hidden vector initializer 112, and input into the first network 113 and second network 114.

The first network calculates the first hidden vector at each local node and the second hidden vector, and outputs them to the second network. The second network 114, into which the hidden vectors have been input, creates the readout vector r and outputs it to the inferencer 24.

The inferencer 24 appropriately processes the input readout vector r, and outputs the processed readout vector r in a form understandable by the user or outputs the processed readout vector r to an appropriate database or the like.

As explained above, according to one embodiment, it is possible to realize the training apparatus 1, which learns the network that outputs the feature of the whole graph when the graph data is input, and to realize the inference apparatus 2 having the network created by the training apparatus 1. The processing of the graph sets the super node coupled to all of the nodes of the graph, defines the hidden vector of the super node, and adaptively merges the hidden vectors of the nodes of the graph and the super node, and can thereby appropriately integrate the individual features of the nodes or edges and the feature which the whole graph has.

Further, since an observation value is input as an initial value of the super node, the feature as the whole graph can be reflected in the network. As explained above, adaptive integration of the hidden vectors having different properties, such as features of the individual nodes and of the whole graph, makes it possible to accurately output the feature of the whole graph. Further, introduction of the attention weight enables creation of a flexible network.

As another example, various kinds of data may be added to the feature amount of the second node. When the graph can be split into two or more sub-graphs which are not connected each other, the number of connected sub-graphs in the graph may be added to the feature amount of the second node. The graph Laplacian or the normalized graph Laplacian of the input graph, computed from the adjacency matrix using a standard formula, may be added to the feature amount of the second node, as well.

For example, at least one of a number of aromatic rings within the input graph, a name of the input graph, or the chirality of the input graph may be added to the feature amount of the second node, in the case of the input graph is a chemical molecule graph. Furthermore, a name of the input graph is, for example, names and identities of the input graph such as compound name, molecular formula, standard identifiers, and so on.

It should be understood that this disclosure is not limited to the above-explained embodiments, and that various modifications may be made to these examples without departing from its scope. For example, the message part 115 may simplify the calculation of the attention weight, such that the calculation may be performed using the same function or the same parameter irrespective of the kind of the edge between the local nodes. Alternatively, the function for calculating the attention weight may be given a weight under a rule fixed in advance in all of the local nodes as a function with no input.

As another example, the message part 115 does not need to take the head into consideration. In other words, the message from the local node may be created assuming that there is only one head with K=1.

As another example, the message part 115 may share some or all of functions or parameters for each layer. In other words, the shared functions or parameters may have the same form and the same value irrespective of layer.

As another example, the merge part 116 may integrate the messages by linear combination or simple arithmetic average by a matrix having fixed parameters not depending on input, in place of sequentially calculating the gate weight. Similar to the message part 115, the merge part 116 may have shared functions or parameters irrespective of layer.

As another example, a recurrent unit having no gating function may be used as the recurrent part 117. For instance, the first hidden vector and the first update hidden vector may be combined using a linear combination function, or the like, and the second hidden vector and the second update hidden vector may be combined using a linear combination function, or the like.

The training apparatus 1 and the inference apparatus 2 may be implemented without using the attention weights. For example, the network may be expressed by using GGNN (Gated Graph Sequence Neural Network) that uses gate functions without attention weights, or by using RSGCN (Renormalized Spectral Graph Convolutional Network) that uses neither gate functions nor attention weights.

A temporal valuable vector a_{l, i} for local node I of l-th layer may be calculated based on output and the adjacency matrix of the (l−1)-th layer.

a_{l,i}=AᵢHₗ₋₁+b (eq. 16)

Here, the matrix Aᵢ is represented by 2D×nD dimension, where n is an amount of the local node and D is a dimension of the hidden vector of the local node (the first hidden vector). When there does not exist the edge between i-th local node and j-th local node, elements from (D×(j−1)+1)-th to (D×j)-th columns of matrix Aᵢ are assumed to be 0. Hₗ₋₁ is a vector, which has nD dimension, concatenating the hidden vectors of N local nodes, a_{l, i} is a 2D-dimensional vector. And, b is a 2D-dimensional bias vector.

As an output, vectors are calculated as an updating amount. A gate vector r and updating vector h\hat{ }_{l, i} is represented as below.

r_{l,i}=σ(W^{(r)}a_{l,i}+U^{(r)}h_{l-1,i}) (eq. 17)

\tilde{h}_{l,i}=tan h(Wa_{l,i}+U(r_{l,i}⊙h_{l-1,i})) (eq. 18)

Here, odot means the element-wise multiple calculations. The final output is also calculated using the gate.

z_{l,i}=σ(W^{(z)}a_{l,i}+U^{(z)}h_{l-1,i}) (eq. 19)

For example, the message part 115 may output h˜_{l, I}, as the first message, which is a concatenated vector based on gate calculated by (eq. 20).

\tilde{h}_{l,i}=(1−z_{l,i})⊙h_{l-1,i}+z_{l,i}⊙\tilde{h}_{l,i} (eq. 20)

By using h˜_{l, i} as the first message, it may be possible to use gate function without attention.

If the message part 115 uses a gate function, the temporary variable vector may be calculated by not only using linear operations but also using non-linear operations.

As another example, neither attention weights nor the gate functions may be used. In this example, Xₗ is a matrix concatenating the hidden vectors of local node for the l-th layer. The dimension of Xₗ is equals to n×D.

$${X}_{l} = {D}^{- \frac{1}{2}} {AD}^{- \frac{1}{2}} {X}_{l - 1} Θ \qquad ( eq . 21 )$$

Matrix A is calculated by summing the adjacency matrix and identity matrix and Θ is a parameter Matrix having same size of matrix Xₗ. Matrix D is a diagonal matrix expressed by (eq. 22).

$${D}_{i , j} = {\sum }_{j} \text{?} \\ \text{?} \text{indicates text missing or illegible when filed} \qquad ( eq . 22 )$$

In this case, vector of i-th line of the matrix Xₗ is used as the outputted vector h˜_{l, i}. As using this message, the network may be expressed neither by using attention weights nor gate functions. The message part 115 may use the non-linear transformation like above.

As described above, the calculation of the first message may be executed by using GCN, or more generally neural network model such as using DNN, which some parts of the networks are replaced appropriate calculations. Therefore, by using the various calculation models, described above or the like, based on the merger part 116, recurrent part 117, and the super-node, it is possible to improve the analysis performance of the graph data.

In the training apparatus 1 and the inference apparatus 2 according to some embodiments, each function may be implemented by a circuit constituted by an analog circuit, a digital circuit, or an analog/digital mixed circuit. A control circuit which controls each function may be included. Each circuit may be implemented as an ASIC (application specific integrated circuit), an FPGA (field programmable gate array), or the like.

In all of the foregoing explanations, at least a part of the training apparatus 1 and the inference apparatus 2 may be constituted by hardware, or by software and a Central Processing Unit (CPU) or the like may implement the function through information processing of the software. When it is constituted by software, programs that enable the training apparatus 1, the inference apparatus 2, and at least a part of the functions may be stored in storage media, such as a flexible disk and a CD-ROM, and may be executed by being read by a computer. The storage media are not limited to detachable media such as a magnetic disk or an optical disk, and may include fixed storage media such as a hard disk device and a memory. That is, the information processing may be concretely implemented using hardware resources. For example, the processing may be implemented on a circuit such as the FPGA, and may be executed by hardware. The generation of the models and the subsequent processing of the model input may be performed by using, for example, an accelerator such as a Graphics Processing Unit (GPU).

For example, a computer may be programmed to act according to the above embodiments by dedicated software stored in a computer-readable storage medium. The kinds of storage media are not limited. The computer may be used to implement a device according to the embodiment by installing dedicated software on the computer, e.g., by downloading the software through a communication network. The information processing is thereby concretely implemented using hardware resources.

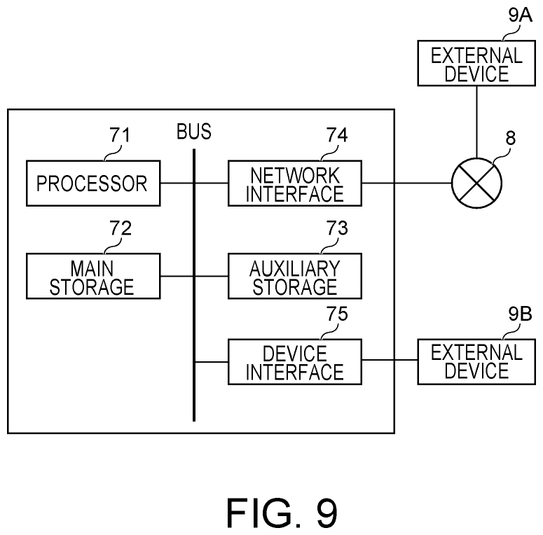

FIG. 9 is a block diagram illustrating an example of a hardware configuration according to some embodiments of the present disclosure. The training apparatus 1 or the inference apparatus 2 may include a computing device 7 having a processor 71, a main storage 72, an auxiliary storage 73, a network interface 74, and a device interface 75, connected through a bus 76.

Although the computing device 7 shown in FIG. 9 includes one of each component 71-76, a plurality of the same components may be included. Moreover, although one computing device 7 is illustrated in FIG. 9, the software may be installed into a plurality of computing devices, and each of the plurality of computing devices may execute a different part of the software process.

The processor 71 may be an electronic circuit (processing circuit) including a control device and an arithmetic logic unit of the computer. The processor 71 performs arithmetic processing based on data and programs input from each device or the like of an internal configuration of the computing device 7, and outputs arithmetic operation results and control signals to each device or the like. For example, the processor 71 may control each component constituting the computing device 7 by executing an OS (operating system), applications, and so on, of the computing device 7. The processor 71 is not limited to a particular processor and may be implemented by any processor capable of performing the above-stated processing.

The main storage 72 stores instructions executed by the processor 71, various data, and so on, and information stored in the main storage 72 may be directly read by the processor 71. The auxiliary storage 73 is a storage other than the main storage 72. These storages may be implemented using arbitrary electronic components capable of storing electronic information, and each may be a memory or a storage. Both a volatile memory and a nonvolatile memory can be used as the memory. The memory storing various data in the training apparatus 1 or the inference apparatus 2 may be formed by the main storage 72 or the auxiliary storage 73. For example, at least one of the storage for the training apparatus 1 or the inference apparatus 2 may be implemented in the main storage 72 or the auxiliary storage 73. As another example, at least a part of the storage may be implemented by a memory which is provided at the accelerator, when an accelerator is used.

The network interface 74 is an interface to connect to a communication network 8 through a wire or wireless interface. An interface which is compatible with an existing communication protocol may be used as the network interface 74. The network interface 74 may exchange information with an external device 9A which is in communication with computing device 7 through the communication network 8.

The external device 9A may include, for example, a camera, a motion capture device, an output destination device, an external sensor, an input source device, and so on. The external device 9A may be a device implementing a part of the functionality of the components of the training apparatus 1 and/or the inference apparatus 2. The computing device 7 may receive a part of processing results of the training apparatus 1 and the inference apparatus 2 through the communication network 8, like a cloud service.

The device interface 75 may be an interface such as a USB (universal serial bus) which directly connects with an external device 9B. The external device 9B may be an external storage medium or a storage device. At least part of the storage may be formed by the external device 9B.

The external device 9B may include an output device. The output device may be, for example, a display device to display images, and/or an audio output device to output sounds, or the like. For example, there external device may include an LCD, (liquid crystal display), a CRT (cathode ray tube), a PDP (plasma display panel), a speaker, and so on. However, the output device is not limited to these examples.

The external device 9B may include an input device. The input device may include devices such as a keyboard, a mouse, a touch panel, or the like, and may supply information input through these devices to the computing device 7. Signals from the input device may be output to the processor 71.

While certain embodiments have been described, these embodiments have been presented by way of example only, and are not intended to limit the scope of the present disclosure. Various additions, modifications, and partial deletion may be made within a range not departing from the conceptual idea and the spirit of the present disclosure which are derived from contents stipulated in the accompanying claims and their equivalents. For example, in all of the above-stated embodiments, numeric values used for the explanation are each presented by way of an example, and not limited thereto. Moreover, while certain processes and methods have been described as a series of steps, it is to be understood that the performance of these steps is not limited to the order described and that non-dependent steps may be performed in any order, or in parallel.

1. A training apparatus for training a network including a first network and a second network, the network being configured to infer a feature of an input graph, the training apparatus comprising one or more memories and one or more processors, wherein the one or more processors are configured to:
merge, by the first network, first hidden vectors of first nodes of the input graph and a second hidden vector of a second node coupled to each of the first nodes, based on the first hidden vectors, the second hidden vector and information on coupling between the first nodes;
update, by the first network, the first hidden vectors and the second hidden vector, based on a result of the merging;
extract, from the second network, the feature of the input graph, based on the updated first hidden vectors and the updated second hidden vector;
calculate a loss of the feature of the input graph; and
update at least one of the first network or the second network, based on the calculated loss.

2. The training apparatus according to claim 1, wherein
the one or more processors are further configured to:
calculate a weight with respect to the first hidden vector and a weight with respect to the second hidden vector;
merge the first hidden vector and the second hidden vector based on the calculated weights to create a first update hidden vector and a second update hidden vector; and
update the first hidden vector based on the first update hidden vector and update the second hidden vector based on the second update hidden vector.

3. The training apparatus according to claim 1, wherein the one or more processors are further configured to update a ratio at which the first hidden vector and the second hidden vector are merged.

4. The training apparatus according to claim 1, wherein the merging includes a gate operation.

5. The training apparatus according to claim 1, wherein the one or more processors are further configured to:
create:
a first message to be transmitted from each of the first nodes updated in a preceding layer to a first node coupled thereto;
a second message to be transmitted from each of the first nodes updated in the preceding layer to the second node;
a third message to be transmitted from the second node updated in the preceding layer to the first node; and
a fourth message to be transmitted from the second node updated in the preceding layer to the second node; and
merge the first hidden vector and the second hidden vector, based at least in part on the first message, the second message, the third message and the fourth message.

6. The training apparatus according to claim 1, wherein the one or more processors are further configured to:
update the first hidden vector based on the first hidden vector updated in a preceding layer and on a result of the merging; and
update the second hidden vector based on the second hidden vector updated in the preceding layer and on the result of the merging.

7. The training apparatus according to claim 1, wherein the one or more processors are further configured to:
calculate the first hidden vectors based on a feature amount of each first node;
extract the information on the coupling between the first nodes from the input graph; and
calculate the second hidden vector based on a feature amount of the second node.

8. The training apparatus according to claim 7, wherein the one or more processors are further configured to extract observation information regarding the input graph as the feature amount of the second node.

9. The training apparatus according to claim 1, wherein the second node coupled to each of the first nodes is a node that is virtually created.

10. The training apparatus according to claim 1, wherein the information on the coupling includes at least one of an adjacency matrix between the first nodes or a tensor expressing coupling between the first nodes.

11. An inference apparatus for inferring a feature of an input graph, the inference apparatus comprising one or more processors and one or more memories, wherein the one or more processors are configured to:
merge first hidden vectors of first nodes of the input graph and a second hidden vector of a second node coupled to each of the first nodes, based on the first hidden vectors, the second hidden vector and information on coupling between the first nodes;
update the first hidden vectors and the second hidden vector, based on a result of the merging; and
extract the feature of the input graph, based on the updated first hidden vectors and the updated second hidden vector.

12. The inference apparatus according to claim 11, wherein the one or more processors are further configured to calculate the second hidden vector from a feature amount of the second node

13. The inference apparatus according to claim 12, wherein the one or more processors are further configured to extract observation information regarding the input graph as the feature amount of the second node.

14. The inference apparatus according to claim 12, wherein the one or more processors are further configured to extract, as the feature amount of the second node, at least one of: a number of the first nodes of the input graph, a number of kinds of the first nodes, a number of kinds of edges mutually coupling the first nodes, a diameter of the input graph, a graph Laplacian of the input graph, a normalized graph Laplacian of the input graph, or a number of connected sub-graphs in the input graph when the input graph is split into more than two sub-graphs which are not connected each other.

15. The inference apparatus according to claim 12, wherein the input graph is a chemical molecular graph, and
the one or more processors are further configured to extract, as the feature amount of the second node, at least one of: a number of aromatic rings within the input graph, a name of the input graph, or a chirality of the input graph.

16. The inference apparatus according to claim 11, wherein the one or more processors are further configured to update a ratio at which the first hidden vector and the second hidden vector are merged.

17. The inference apparatus according to claim 11, wherein the second node coupled to each of the first nodes is a node that is virtually created.

18. The inference apparatus according to claim 11, wherein the information on the coupling includes at least one of an adjacency matrix between the first nodes or a tensor expressing coupling between the first nodes.

19. A network creation method of creating a network, the network being configured to infer a feature of an input graph, the network creation method comprising:
merging, by one or more processors, first hidden vectors of first nodes of the input graph and a second hidden vector of a second node coupled to each of the first nodes, based on the first hidden vectors, the second hidden vector, and information on coupling between the first nodes;
updating, by the one or more processors, the first hidden vectors and the second hidden vector, based on a result of the merging;
extracting, by the one or more processors, the feature of the input graph, based on the updated first hidden vectors and the updated second hidden vector;
calculating, by the one or more processors, a loss of the extracted feature of the input graph; and
updating, by the one or more processors, at least a part of the network, based on the loss.

20. An inference method of inferring a feature of an input graph, the inference method comprising:
merging, by one or more processors, first hidden vectors of first nodes of the input graph and a second hidden vector of a second node coupled to each of the first nodes, based on the first hidden vectors, the second hidden vector and information on coupling between the first nodes;
updating, by the one or more processors, the first hidden vectors and the second hidden vector, based on a result of the merging; and
extracting, by the one or more processors, the feature of the input graph, based on the updated first hidden vectors and the updated second hidden vector.
